(19) United States
(12) Patent Application Publication
(10) Pub. No.: US 2017/0011316 A1
(43) Pub. Date: Jan. 12, 2017

(54) Communications Monitoring System

(71) Applicant: ADP, LLC, Roseland, NJ (US)

(72) Inventors: Matthew Paul Herman, Hoboken, NJ (US); Omar Scott, New York, NY (US); Hadar Yacobovitz, New York, NY (US)

(21) Appl. No.: 14/795,243

(22) Filed: Jul. 9, 2015

(51) Int. Cl. G06Q 10/06; H04L 29/06

(52) U.S. Cl. CPC G06Q 10/06313; H04L 65/403

(57) ABSTRACT

A method, computer system and computer program product for managing communications. A computer system monitors a use of communications used by a group of people in a communications system and displays the use of the communications by the group of people on a radar chart in a graphical user interface in a display system. The radar chart has axes extending from a common origin in which the axes correspond to the use of the communications. The computer system identifies a group of potential changes to the communications in the communications system based on a policy applied to the use monitored for in the communications. The computer system displays the group of potential changes in association with the radar chart in the graphical user interface, enabling a more efficient use of the communications system.

### BACKGROUND INFORMATION

1. Field

The present disclosure relates generally to an improved communications system and, in particular, to a method and apparatus for monitoring communications in a communications system. Still more particularly, the present disclosure relates to a method and apparatus for identifying metrics about communications channels used in a communications system.

2. Background

Communications channels are used by people in organizations for many different purposes. Communications may be sent over communications channels to perform operations such as research, payroll, marketing, planning, managing employees, administering benefits, customer support, sales, and other suitable purpose. These operations are performed to meet objectives for an organization. The objectives may include sales objectives, research objectives, manufacturing objectives, as well as other types of objectives.

For example, in performing research for a product in an organization, a team of people may communicate with each other to perform the research. The people in the team may send email messages to each other, post on a form set up for the research, engage in videoconferences, or use other types of communications channels to perform the research for the product.

As another example, a sales team may work with each other and potential customers using various types of communications channels. The people in the sales team may communicate with each other and with customers using email. As another example, the people in the sales team also may employ social media networks to reach and communicate with customers.

The use of these communications channels often changes over time. For example, as projects begin and complete within an organization, the types and amounts of communications over the same or new communications channels may change based on the beginning and completion of the projects. As a result, the resources allocated to communications channels may not be sufficient as the use of communications channels change.

For example, when a new product is introduced, a marketing group may promote the new product. This promotion of the new product may occur using various communications channels such as emails, social networks, telephone systems, professional networks, websites, or other suitable types of communications channels.

The increased use of a communications channel may use more resources than allocated for the communications channel needed to provide for efficient communication using the communications channel. For example, with a new product, promotion of the product over the website may result in more visits to the website and inquiries being generated through the website.

The increased number of inquiries may be more than the website can handle with the current level of resources allocated to the website. As a result, the experience of a visitor to the website may not be as pleasant or efficient as desired if delays occur in viewing portions of the website or making inquiries for more information.

Website monitoring processes may be used to identify when traffic exceeds resources. Additional resources may be allocated for the website to handle increased traffic when the traffic is identified as being greater than can be handled by the resources currently allocated to the website.

As another example, when a research project begins, people of the research team may have discussions using email messages that may include documents attached to the email messages. If the documents are larger than the size allowed by the email system, a system message may be generated saying that the attachment cannot be added to the message or that the message has been rejected by the receiving email system.

People in the research team may break up a document in to multiple documents and send them over multiple emails. This type of communication using email messages, however, is less efficient than desired for exchanging communications.

A solution involves increasing the size allowed for email attachments or using a different communications channel that allows for larger documents to be sent. This type of situation, however, is not a situation that is easily identifiable using monitoring processes. As a result, changes may only occur in response to complaints generated by the research team.

Therefore, it would be desirable to have a method and apparatus that take into account at least some of the issues discussed above, as well as other possible issues. For example, it would be desirable to have a method and apparatus that overcome a technical problem with managing resources for communications channels in a communications system.

### SUMMARY

An embodiment of the present disclosure provides a method for managing communications. A computer system monitors a use of communications by a group of people in a communications system and displays the use of the communications by the group of people on a radar chart in a graphical user interface in a display system. The radar chart has axes extending from a common origin in which the axes correspond to the use of the communications. The computer system identifies a group of potential changes to the communications in the communications system based on a policy applied to the use monitored for in the communications. The computer system displays the group of potential changes in association with the radar chart in the graphical user interface, enabling a more efficient use of the communications system.

An embodiment of the present disclosure provides a computer system comprising a display system and a communications manager in communication with the display system. The communications manager monitors a use of communications by a group of people in a communications system and displays the use of the communications by the group of people on a radar chart in a graphical user interface in a display system. The radar chart has axes extending from a common origin in which the axes correspond to the use of the communications. The communications manager identifies a group of potential changes to the communications in the communications system based on a policy applied to the use monitored for in the communications and displays the group of potential changes in association with the radar chart in the graphical user interface, enabling a more efficient use of the communications system.

An embodiment of the present disclosure provides a computer program product for managing communications comprising a computer readable storage media, and first program code, second program code, third program code, fourth program code stored on the computer readable storage media. The first program code monitors a use of communications by a group of people in a communications system. The second program code displays the use of the communications by the group of people on a radar chart in a graphical user interface in a display system. The radar chart has axes extending from a common origin in which the axes correspond to the use of the communications. The third program code identifies a group of potential changes to the communications in the communications system based on a policy applied to the use monitored for in the communications. The fourth program code displays the group of potential changes in association with the radar chart in the graphical user interface, enabling a more efficient use of the communications system.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of an information environment in accordance with an illustrative embodiment;

FIG. 2 is an illustration of a block diagram of a communications manager in accordance with an illustrative embodiment;

FIG. 3 is an illustration of a block diagram of data flow for identifying information about the use of communications channels by people in accordance with an illustrative embodiment;

FIG. 4 is an illustration of a block diagram of data flow for identifying potential changes to communications in accordance with an illustrative embodiment;

FIG. 5 is an illustration of a block diagram of objectives in accordance with an illustrative embodiment;

FIG. 6 is an illustration of a block diagram of potential changes in accordance with an illustrative embodiment;

FIG. 7 is an illustration of a block diagram of data flow for managing communications in accordance with an illustrative embodiment;

FIG. 8 is an illustration of a block diagram of data flow for tagging communications in accordance with an illustrative embodiment;

FIG. 9 is an illustration of a radar chart in a graphical user interface for managing communications in accordance with an illustrative embodiment;

FIG. 10 is an illustration of a radar chart in a graphical user interface for managing communications in a graphical user interface in accordance with an illustrative embodiment;

FIG. 11 is an illustration of a control in a graphical user interface for managing communications in a graphical user interface in accordance with an illustrative embodiment;

FIG. 12 is an illustration of a radar chart in a graphical user interface for managing communications in a graphical user interface in accordance with an illustrative embodiment;

FIG. 13 is an illustration of a radar chart in a graphical user interface for managing communications in a graphical user interface in accordance with an illustrative embodiment;

FIG. 14 is an illustration of a flowchart of a process for managing communications in accordance with an illustrative embodiment;

FIG. 15 is an illustration of a flowchart of a process of steps that may be performed to change an allocation of resources for communications channels based on a visualization of the use of communications channels by a group of people in a radar chart in accordance with an illustrative embodiment;

FIG. 16 is an illustration of a flowchart of a process for monitoring a use of communications channels in accordance with an illustrative embodiment;

FIG. 17 is an illustration of a flowchart of a process for identifying potential changes to communications in accordance with an illustrative embodiment;

FIG. 18 is an illustration of a flowchart of a process for tagging communications in accordance with an illustrative embodiment; and

FIG. 19 is an illustration of a block diagram of a data processing system in accordance with an illustrative embodiment.

### DETAILED DESCRIPTION

The illustrative embodiments recognize and take into account one or more different considerations. For example, the illustrative embodiments recognize and take into account that currently used monitoring systems often generate alarms or send messages when the threshold of resources used in a communications channel is exceeded. The illustrative embodiments recognize and take into account that this type of approach is often more reactive than proactive. In some cases, when a threshold is exceeded, the time needed to plan or allocate new resources for the communications channel may be greater than desired.

For example, the resources allocated to the communications channel may become insufficient before additional resources are allocated to the communications channel. Additionally, the illustrative embodiments also recognize and take into account that alerts or messages do not provide a desired level of information for planning allocations of resources for communications channels.

The illustrative embodiments recognize and take into account that it would be desirable to visualize allocations of resources for communications channels. The illustrative embodiments also recognize and take into account that it would be desirable to identify changes that may be needed in the allocation of resources for communications channels.

In one illustrative example, a method and apparatus are present for managing communications. A computer system monitors a use of communications used by a group of people in a communications system. As used herein, “a group of,” when used with reference to items, means one or more items. For example, “a group of people” is one or more people.

The computer system displays the use of the communications by the group of people on a radar chart in a graphical user interface in a display system. The radar chart has axes extending from a common origin in which the axes correspond to the use of the communications. The computer system identifies a group of potential changes to communications in the communications system based on a policy applied to the use monitored for in the communications. The computer system displays the group of potential changes in association with the radar chart in the graphical user interface, enabling a more efficient use of the communications system.

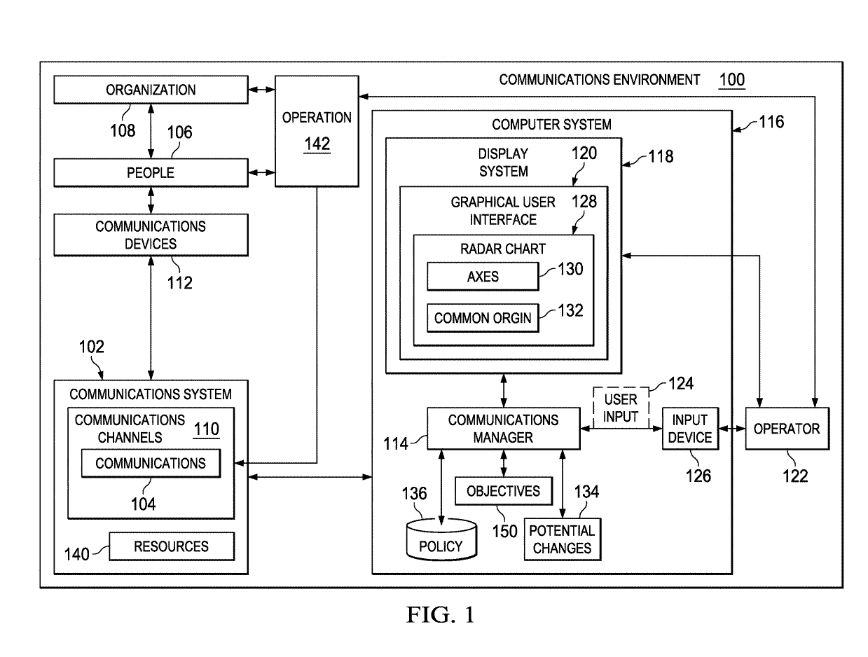

With reference now to the figures and, in particular, with reference to FIG. 1, an illustration of a block diagram of an information environment is depicted in accordance with an illustrative embodiment. As depicted, communications environment 100 includes communications system 102. Communications system 102 is used to exchange communications 104 between people 106. In the illustrative example, people 106 may be part of organization 108 or external to organization 108.

Organization 108 may take various forms. For example, organization 108 may be a company, a partnership, a charity, an educational group, a social group, a team, a government entity, or some other suitable organization.

As depicted, communications 104 are sent using communications channels 110. A communications channel is a physical hardware system that facilitates a transmission of information that forms a communication in communications 104. The physical hardware may include at least one of a data processing system, a computer, a router, a switch, or some other suitable hardware device. For example, communications channels 110 may be selected from at least one of an electronic mail system, an instant messaging message system, a message board, a private message system, a forum, a voice mail system, a public switched telephone network, a voice over internet protocol call system, a video conference system, social networks, professional networks, or some other suitable hardware system that facilitates a flow of information for communications 104.

As used herein, the phrase “at least one of,” when used with a list of items, means different combinations of one or more of the listed items may be used and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In the illustrative example, communications 104 may take various forms. For example, communications 104 may be selected from at least one of an electronic mail message, a chat message, a document, voice data, an image, video data, a program, or other suitable forms of information.

As depicted, people 106 exchange communications 104 over communications channels 110 using communications devices 112. Communications devices 112 may include at least one of a computer, a mobile phone, a lap top computer, a server computer a workstation, a tablet computer, or some other suitable device.

In the illustrative example, communications manager 114 manages communications made over communications channels 110 by people 106. Communications manager 114 may be implemented in software, hardware, firmware or a combination thereof. When software is used, the operations performed by communications manager 114 may be implemented in program code configured to run on hardware, such as a processor unit. When firmware is used, the operations performed by communications manager 114 may be implemented in program code and data and stored in persistent memory to run on a processor unit. When hardware is employed, the hardware may include circuits that operate to perform the operations in communications manager 114.

In the illustrative examples, the hardware may take the form of a circuit system, an integrated circuit, an application-specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semiconductors.

In the illustrative example, communications manager 114 may be implemented in computer system 116. Computer system 116 is a hardware system and includes one or more data processing systems. When more than one data processing system is present, those data processing systems may be in communication with each other using a communications medium. The communications medium may be a network. The data processing systems may be selected from at least one of a computer, a server computer, a tablet, or some other suitable data processing system.

Further, computer system 116 includes display system 118. Display system 118 is a hardware system and includes one or more display devices on which graphical user interface 120 may be displayed. The display devices may include at least one of a light-emitting diode display (LED), a liquid crystal display (LCD), and organic light-emitting diode display (OLED), or some other suitable device on which graphical user interface 120 can be displayed. Operator 122 may interact with graphical user interface 120 through user input 124 generated by input device 126 in computer system 116. Input device 126 may be, for example, a mouse, a keyboard, a trackball, a touchscreen, a stylus, or some other suitable type of input device.

Graphical user interface 120 displayed in display system 118 is used by operator 122 to visualize information and interface with communications manager 114. Operator 122 is a person and may be a person in people 106.

In operation, communications manager 114 monitors a use of communications 104 used by a group of people 106 in communications system 102. As depicted, communications manager 114 may monitor the use of communications 104 as used by the group of people 106 in a form selected from at least one of communications channels 110 and objectives 150. In this example, the use is selected from at least one of a number of communications, bandwidth used for the communications, how long the communications last, resources used, content in the communications, a sender of the communications, a recipient of the communications, or some other type of use.

In one illustrative example, communications manager 114 monitors the use of communications 104 by monitoring the use of communications channels 110 by the group of people 106. When monitoring the use of communications 104 in the form of communications channels 110, the use of communications channels 110 is a characteristic of communications channels 110 that can be measured. For example, the use of communications channels 110 may be selected from at least one of the number of communications, bandwidth used for the communications, how long the communications last, resources used, or some other type of use that can be measured.

In this illustrative example, communications manager 114 also may monitor communications 104 made by the group of people 106 in communications system 102 for the use of communications 104 that are related to a group of objectives 150. As depicted, objectives 150 are selected from at least one of sales, marketing, product development, research, corporate operations, public relations, customer satisfaction, or some other suitable objective.

The identification of communications 104 that are related to a group of objectives 150 may be identified in a number different ways. For example, whether a communication in communications 104 is one related to the group of objectives 150 may be identified from looking at at least one of communications 104.

In the illustrative example, communications manager 114 displays the use of communications 104 by the group of people 106 on radar chart 128 in graphical user interface 120 in display system 118. Radar chart 128 has axes 130 extending from common origin 132. Axes 130 correspond to at least one of communications channels 110 or objectives 150.

As depicted, communications manager 114 identifies a group of potential changes 134 to communications 104 in communications system 102 based on policy 136 applied to the use monitored for in communications 104. The group of potential changes 134 may be selected from at least one of how communications 104 are made, who made communications 104, the allocation of resources to communications channels 110, of some other potential changes.

In the illustrative example, the group of potential changes 134 is selected from at least one of a change in resources 140 allocated in communications system 102, a priority of use for the types of communications 104, a change in how people 106 make communications 104, a priority of use for communications channels 110, an addition of a new communications channel, a removal of a current communications channel, or some other change that may be made with respect to communications 104. In this example, policy 136 includes a group of rules selected from at least one of increasing a goal of the communications, increasing contributions by the group of people using the communications system, meeting an objective, reducing the cost of the communications system, or some other suitable rule.

Further, communications manager 114 displays the group of potential changes 134 in association with radar chart 128 in graphical user interface 120. These different operations enable a more efficient use of communications system 102.

With the visualization of potential changes 134 in graphical user interface 120 on display system 118, operator 122 may perform operation 142. As depicted in this example, operation 142 is made with respect to at least one of communications channels 110, people 106, or organization 108.

In one illustrative example, potential changes 134 may be implemented in using operation 142 through interaction with communications manager 114 by operator 122. For example, operator 122 may interact with communications manager 114 by sending user input 124 that changes allocation of resources 140 for communications channels 110.

In one illustrative example, one or more technical solutions are present that overcome a technical problem with managing resources 140 for communications channels 110 in communications system 102. With communications manager 114 displaying the use of communications channels 110 in radar chart 128, communications manager 114 in computer system 116 provides a visualization of information that may be used by operator 122 or other people to manage communications system 102.

Further, communications manager 114 also identifies a group of potential changes 134 and displays the group of potential changes 134 in graphical user interface 120 in association with the display of radar chart 128. Operator 122 also may interact with communications manager 114 through graphical user interface 120 to implement one or more of potential changes 134. In this manner, the technical effect of a more efficient use of communications system 102 may occur using one or more of the technical solutions in this disclosure.

As a result, computer system 116 operates as a special purpose computer system in which communications manager 114 in computer system 116 enables visualizing the use of resources 140 for communications channels 110 through radar chart 128, visualizing potential changes 134 that may be made to communications 104, or some combination thereof. Potential changes 134 may be made to communications channels 110 or how people 106 use communications channels 110 in making changes to communications 104 in the illustrative example. In particular, communications manager 114 transforms computer system 116 into a special purpose computer system as compared to currently available general computer systems that do not have communications manager 114.

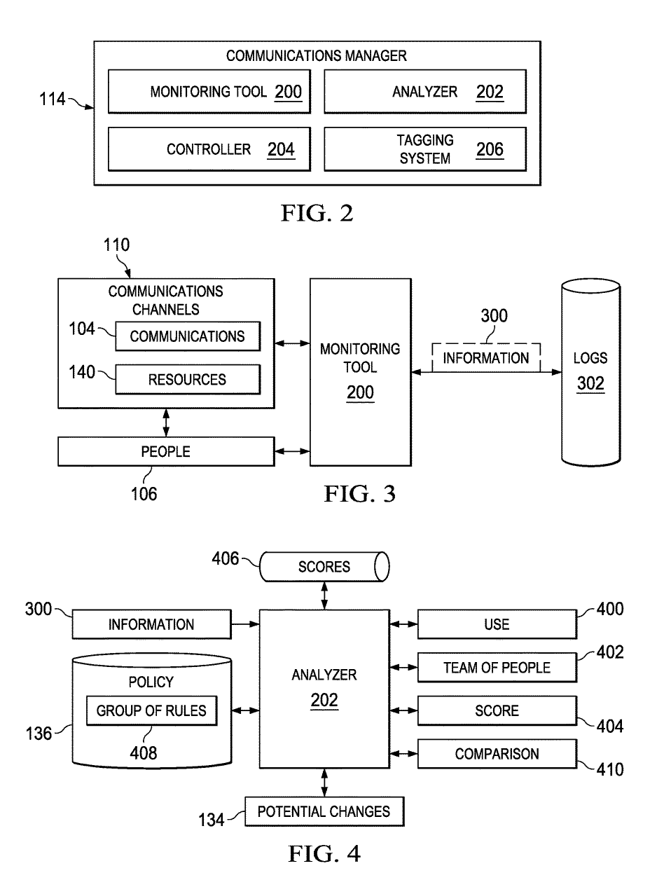

In FIG. 2, an illustration of a block diagram of a communications manager is depicted in accordance with an illustrative embodiment.

In this illustrative example, communications manager 114 has a number of different components. As depicted, communications manager 114 includes monitoring tool 200, analyzer 202, controller 204, and tagging system 206.

Monitoring tool 200 identifies information about the use of communications channels 110 by people 106 in communications system 102 in FIG. 1. In this illustrative example, the information identified is selected from at least one of how many times communications 104 occurred between people 106 over communications channels 110, amounts of bandwidth used by communications 104 over communications channels 110, or amounts of resources 140 of communications channels 110 used by communications 104 between people 106.

As depicted, analyzer 202 identifies a use of communications channels 110 by a group of people 106 from the information identified by monitoring tool 200. Analyzer 202 identifies potential changes 134 to communications 104 for the group of people 106. For example, analyzer 202 may identify potential changes 134 by comparing policy 136 to at least one of the use of communications channels 110 by the group of people 106, a score for the group of people 106, or a combination of the use and the score.

When a group of people 106 includes two or more people, the group of people 106 is people who are connected in some way. For example, the group of people 106 may be selected from a department, a team, a division, a number of people performing a task, or any other suitable type of groups of people.

A score for a group of people 106 is a measure of success for the group of people 106. For example, a score for the group of people 106 may be for at least one of profit, customer satisfaction, productivity, or some other suitable type of score for measuring success. In the illustrative examples, a score for the group of people 106 is increased through communications 104 when communications 104 take place over communications channels 110. For example, when a service team uses a communications channel to make service calls with customers, the service calls are communications that increase customer satisfaction.

In this illustrative example, controller 204 manages communications 104 made over communications channels 110 by people 106. Controller 204 manages communications 104 by displaying a use of communications channels 110 for communications 104 between people 106; displaying potential changes 134 to communications 104; and then making changes to communications 104 based on user input 124.

In this illustrative example, controller 204 generates radar chart 128 for display on graphical user interface 120. For example, controller 204 may generate radar chart 128 to show the use of communications channels 110 in radar chart 128 by people 106 in organization 108. Controller 204 displays potential changes 134 on graphical user interface 120. Controller 204 also processes requests in user input 124 to at least one of implement potential changes 134 or to make other changes to communications 104 for the group of people 106.

As depicted, tagging system 206 identifies objectives 150 for communications 104. Tagging system 206 identifies objectives 150 using tags. In these illustrative examples, tags are identifiers that specify objectives of communications. For example, when a communication in communications 104 is assigned the tag “sales”, the communication is for sales. Tags may be selected from at least one of alphanumeric text, icons, or other suitable types of identifiers.

In this illustrative example, tags are assigned to communications 104. Tagging system 206 assigns tags by at least one of comparing the content of communications 104 to objectives, or from user input 124. For example, tagging system 206 may assign tags to communications 104 by comparing objectives 150 to content of communications 104.

Turning to FIG. 3, an illustration of a block diagram of data flow for identifying information about the use of communications channels by people is depicted in accordance with an illustrative embodiment. In this illustration, an example of data flow for identifying information about a use of communications channels 110 by people 106 through monitoring tool 200 is shown.

In this illustrative example, monitoring tool 200 identifies information 300 about a use of communications channels 110. As depicted, monitoring tool 200 intercepts communications 104 on communications channels 110 to identify information 300. When monitoring tool 200 identifies information 300 by intercepting communications 104, monitoring tool 200 identifies information 300 by parsing communications 104.

For example, a communications channel may include a port on computer system 116 which is used to transmit and receive emails. In this example, monitoring tool 200 intercepts the emails by listening for simple mail transfer protocol packets which are transmitted over the port of computer system 116. Monitoring tool 200 then identifies information 300 by parsing the simple mail transfer protocol packets.

As depicted, when communications channels 110 are enabled to provide information 300, monitoring tool 200 may receive information 300 from communications channels 110. For example, monitoring tool 200 may use an application programming interface (API) provided by a communications channel to request information 300 about use of the communications channel.

In this illustrative example, the communications channel provides information 300 to monitoring tool 200 as a response to the request for information 300. As depicted, information 300 includes at least one of counts of how many communications 104 occurred between people 106 using communications channels 110, amounts of bandwidth used by communications 104 between people 106 over communications channels 110, amounts of resources 140 used for communications 104 between people 106, amounts of resources 140 allocated to communications 104 between people 106, purposes of communications 104 between people 106, people 106 that initiated communications 104, people 106 assigned to communications 104, people 106 that received communications 104, people 106 that responded to communications 104, or some other suitable type of information about the use of communications channels 110 for communications 104 between people 106.

As depicted, monitoring tool 200 stores information 300 in logs 302. In this illustrative example, logs 302 are files located on storage devices. For example, a log in logs 302 may be a file in a file system on a hard drive in communications environment 100.

In this illustrative example, each log in logs 302 is for a range of time. The range of time for a log in logs 302 is selected from at least one of hours, days, weeks, months, or some other suitable range of time. For example, a first log in logs 302 may be for a first day, and a second log in logs 302 may be for a second day.

Turning next to FIG. 4, an illustration of a block diagram of data flow for identifying potential changes to communications is depicted in accordance with an illustrative embodiment. In this illustration, an example of data flow for identifying the group of potential changes 134 to communications 104 based on policy 136 through analyzer 202 is shown.

As depicted, analyzer 202 identifies use 400 of communications channels 110 of communications system 102 by team of people 402 from information 300. In this illustrative example, use 400 is selected from at least one of counts of how many communications 104 occurred between team of people 402 using communications channels 110, amounts of bandwidth used by communications 104 between team of people 402 over communications channels 110, amounts of resources 140 used for communications 104 between team of people 402, or some other type of use that can be measured.

Team of people 402 is an example of a group of people 106 that operates as a team. A team is a group of people 106 that performs tasks together. In this illustrative example, team of people 402 is selected from at least one of a sales team, a service team, a product development team, a management team, or some other suitable type of team for organization 108.

Analyzer 202 identifies score 404 for team of people 402 from scores 406. Score 404 for team of people 402 is selected from at least one of profit, customer satisfaction, productivity, or some other suitable type of score for team of people 402.

In this illustrative example, score 404 for team of people 402 is increased through communications 104 that team of people 402 participated in over communications channels 110. For example, when team of people 402 is a sales team and score 404 is profit, the sales team may use communications channels 110 to make sales calls with customers. In this example, these sales calls are communications 104 that increase profit.

As depicted, policy 136 includes group of rules 408. Group of rules 408 is selected from at least one of a rule for increasing a goal of communications 104, a rule for increasing contributions by team of people 402 using communications system 102, a rule for reducing cost of communications system 102, or some other suitable types of rules.

A goal of communications 104 is a target for use 400 of communications 104. The target for use 400 of communications 104 is selected from at least one of priority for using communications channels 110 for communications 104, a percent of utilization of resources 140 allocated to team of people 402 for communications 104 made over communications channels 110, or some other suitable target for use 400 of communications 104.

A percent of utilization of a resource is an indicator for whether the resource is underutilized or fully utilized. When the percent of utilization of the resource allocated to team of people 402 is 100 percent, the resource is being used as much as is possible by team of people 402. An increase to the amount of the resource allocated to team of people 402 reduces the percent of utilization of the resource allocated to team of people 402.

Analyzer 202 generates comparison 410 between group of rules 408 in policy 136 and at least one of use 400, score 404, or a combination of use 400 and score 404. Analyzer 202 determines whether a group of potential changes 134 are needed to communications 104 based on comparison 410. The group of potential changes 134 is selected from at least one of a change in resources 140 allocated in communications system 102, a change in how team of people 402 makes communications 104, a priority of use 400 for types of communications 104, a priority of use 400 for communications channels 110, an addition of a new communications channel to communications channels 110, a removal of a current communications channel from communications channels 110, or other suitable types of potential changes.

For example, when team of people 402 is a sales team and a percent of utilization of a communications channel in communications channels 110 for the sales team does not meet a rule in group of rules 408, analyzer 202 identifies an increase to resources 140 allocated to the communications channel in communications system 102 for the sales team based on comparison 410. Analyzer 202 then adds this increase to resources 140 as a potential change in group of potential changes 134.

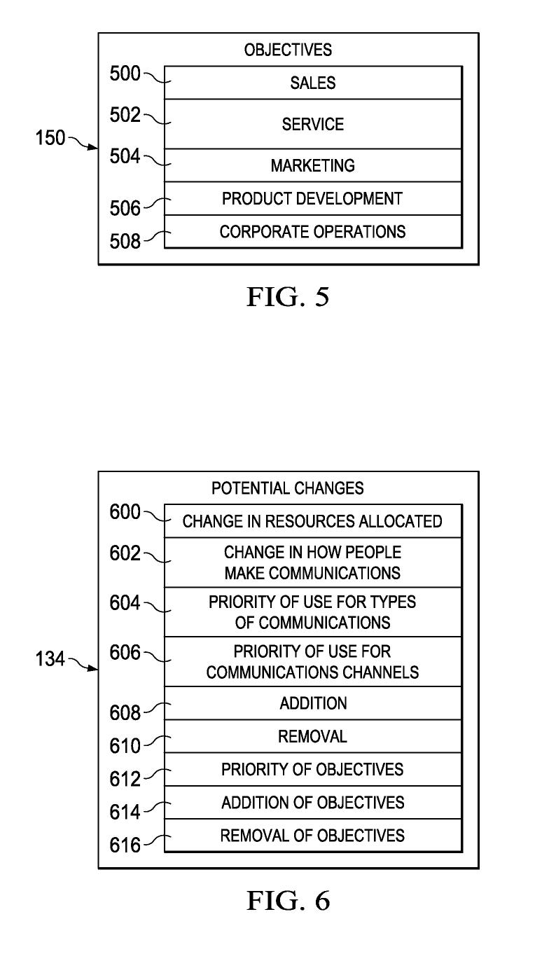

Turning to FIG. 5, an illustration of a block diagram of objectives is depicted in accordance with an illustrative embodiment. As depicted, examples of objectives that may be in objectives 150 in FIG. 1 are shown. In this illustrative example, objectives 150 include sales 500, service 502, marketing 504, product development 506, and corporate operations 508.

As depicted, sales 500 is an objective for a group of people 106 in organization 108 for making sales. Each objective in objectives 150 may include sub-objectives. A sub-objective is a sub-type of the objective with more specificity than the objective. For example, sub-types for sales 500 may be selected from at least one of push sales, sales from leads, in-bound order sales, or other suitable types of sales 500.

Service 502 is an objective for a group of people 106 in organization 108 for solving problems for customers. Sub-types of service 502 may be selected from at least one of customer service calls, problem solving, or other suitable types of service 502.

Marketing 504 is an objective for a group of people 106 in organization 108 for increasing public awareness of at least one of a brand or a product. Sub-types of marketing 504 may be selected from at least one of direct marketing, multi-level marketing, television presentation, or other suitable types of marketing 504.

Product development 506 is an objective for a group of people 106 in organization 108 for developing products. Sub-types of product development 506 may be selected from at least one of engineering, testing, documentation, or other suitable tasks needed in the development of products.

As depicted, corporate operations 508 is an objective for a group of people 106 in organization 108 for managing operations of organization 108. Sub-types of corporate operations 508 may be selected from at least one of evaluating risk, examining premises, exploring alternative solutions, examining facts, testing solutions, or other suitable types of operations for organization 108.

Turning now to FIG. 6, an illustration of a block diagram of potential changes is depicted in accordance with an illustrative embodiment. As depicted, examples of changes that may be in potential changes 134 in FIG. 1 are shown. In this illustrative example, potential changes 134 include change in resources allocated 600, change in how people make communications 602, priority of use for types of communications 604, priority of use for communications channels 606, addition 608 of a new communications channel, removal 610 of a current communications channel, priority of objectives 612, addition of objectives 614, and removal of objectives 616.

As depicted, change in resources allocated 600 is a value for an amount of change to resources 140 allocated. The value may be selected from at least one of a number or a percentage.

In this illustrative example, the amount of change to resources 140 allocated is for at least one of communications 104 between people 106, communications 104 for team of people 402, a type of communications 104 between people 106, a communications channel in communications channels 110 for communications 104 between people 106, or some other suitable type of allocation of resources 140.

As depicted, change in how people make communications 602 identifies a group of communications channels 110 to use for communications 104. As depicted, the identification of the group of communications channels 110 to use for communications 104 is for at least one of communications 104 between people 106, communications 104 for team of people 402, a type of communications 104 between people 106, or some other suitable type of identification of communications channels 110 to use for communications 104.

In this illustrative example, priority of use for types of communications 604 is a value indicating which of the types of communications 104 are the preferred types of communications 104. For example, when a priority of use 400 for a first type of communications is higher than a priority of use 400 for a second type of communications, the first type of communications is preferred over the second type of communications.

Similarly, priority of use for communications channels 606 is a value indicating which communications channels in communications channels 110 are the preferred communications channels. For example, when a priority of use 400 for a first communications channel is higher than a priority of use 400 for a second communications channel, the first communications channel is preferred over the second communications channel.

A new communications channel is a communications channel that may be added to communications channels 110. The new communications channel may be in addition to current communications channels or may be replacement for a current communications channel in communications channels 110. A current communications channel is a communications channel that is already present in communications channels 110.

As depicted, priority of objectives 612 is a value indicating which of objectives 150 for communications 104 are the preferred objectives for use 400. For example, when a priority of a first objective is higher than a priority of a second objective for use 400, the first objective is preferred over the second objective for use 400 of communications 104.

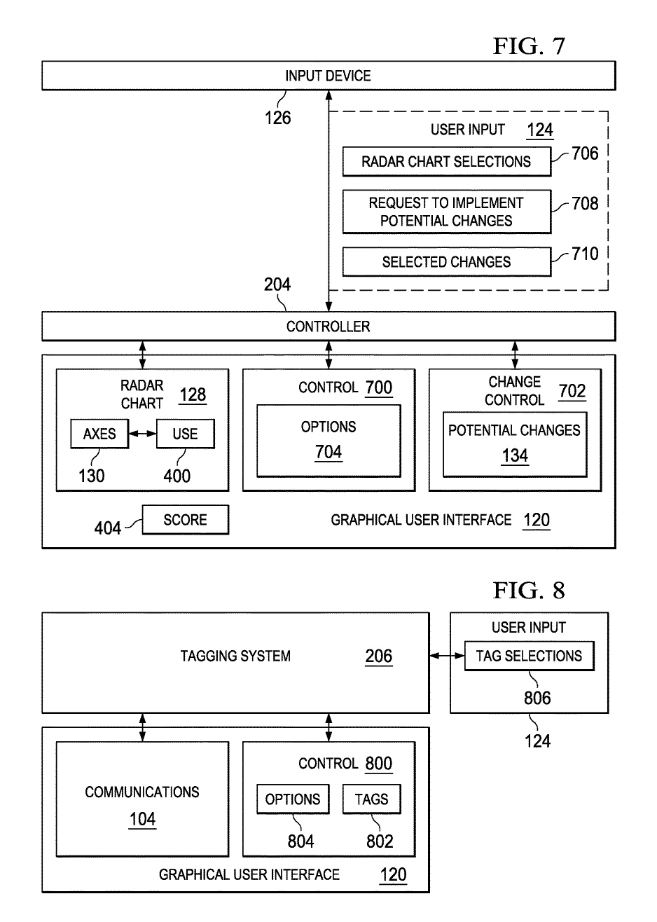

With reference to FIG. 7, an illustration of a block diagram of data flow for managing communications is depicted in accordance with an illustrative embodiment. In this illustration, an example of data flow for managing communications 104 made over communications channels 110 by people 106 through controller 204 is shown.

In this illustrative example, graphical user interface 120 includes radar chart 128, control 700, score 404, and change control 702. As depicted, controller 204 provides access to use 400 of communications channels 110 through control 700. Controller 204 provides access to manage communications through change control 702. Control 700 and change control 702 are graphical controls. A graphical control is a control displayed in graphical user interface 120. Controller 204 displays control 700, score 404, and change control 702 in graphical user interface 120.

As depicted, control 700 includes options 704 for what to show in radar chart 128. Controller 204 receives radar chart selections 706 from options 704 in user input 124 to control 700. Options 704 are selected from at least one of the types of use of communications channels 110 to be compared in radar chart 128, teams of people to be compared in radar chart 128, purposes of communications 104 to be compared in radar chart 128, or a rule for grouping axes 130 of radar chart 128.

In this illustrative example, the types of use 400 of communications channels 110 to be compared in radar chart 128 are selected from at least one of counts of how many communications in communications 104 occurred between teams of people 106 using communications channels 110, amounts of bandwidth used by communications 104 between teams of people 106 over communications channels 110, amounts of resources 140 used for communications 104 between teams of people 106, or some other type of use of communications channels 110.

In this example, the purposes of communications 104 to be compared in radar chart 128 are selected from at least one of types of sales, types of services, types of marketing, types of product development, or other suitable types of communications 104. The rule for grouping axes 130 of radar chart 128 is selected from at least one of group axes 130 by types of communications channels 110, group axes 130 by providers of communications channels 110, axes 130 are not grouped, or some other suitable rule for grouping of communications channels 110. For example, when the rule for grouping axes 130 of radar chart 128 groups axes 130 by providers of communications channels 110, controller 204 places axes 130 into groups of axes 130 based on the providers of communications channels 110.

As depicted, controller 204 generates radar chart 128 for display on graphical user interface 120 based on radar chart selections 706. In this illustrative example, radar chart selections 706 include team of people 402 selected from teams of people 106. As depicted, when radar chart selections 706 include team of people 402, controller 204 displays score 404 for team of people 402 in graphical user interface 120.

In this illustrative example, controller 204 includes use 400 of communications channels 110 of communications system 102 by team of people 402 on axes 130 in radar chart 128. For example, controller 204 may generate radar chart 128 to show counts of how many communications 104 occurred between team of people 402 using communications channels 110.

Controller 204 displays potential changes 134 to communications 104 in change control 702. In this illustrative example, controller 204 receives at least one of request to implement potential changes 708 or selected changes 710 to communications 104 in user input 124 from input device 126. As depicted, user input 124 manipulates change control 702 displayed in graphical user interface 120. When controller 204 receives request to implement potential changes 708, controller 204 implements potential changes 134.

For example, when potential changes 134 include removal 610 of a communications channel, controller 204 removes the communications channel from communications channels 110. As another example, when potential changes 134 include priority of use for types of communications 604 for team of people 402, controller 204 sends priority of use for types of communications 604 to team of people 402. In this illustrative example, controller 204 sends priority of use for types of communications 604 to team of people 402 via at least one of a message, an email, or some other suitable type of notification.

Selected changes 710 are selected from at least one of a change in resources 140 allocated in communications system 102, a change in how team of people 402 make communications 104, a priority of use 400 for types of communications 104, a priority of use 400 for communications channels 110, an addition of a new communications channel to communications channels 110, a removal of a current communications channel from communications channels 110, or other suitable types of changes. When controller 204 receives selected changes 710, controller 204 implements selected changes 710.

With reference next to FIG. 8, an illustration of a block diagram of data flow for tagging communications is depicted in accordance with an illustrative embodiment. In this illustration, an example of data flow for tagging communications 104 made over communications channels 110 by people 106 through tagging system 206 is shown.

In this illustrative example, graphical user interface 120 includes communications 104 and control 800. As depicted, tagging system 206 provides access to tags 802 assigned to communications 104 through control 800. Tagging system 206 provides access to manage tags 802 for communications 104 through control 800.

As depicted, control 800 includes options 804 for managing tags 802 assigned to communications 104. Tagging system 206 receives tag selections 806 from options 804 in user input 124 to control 800. Options 804 are selected from at least one of assigning a tag in tags 802 to a communication in communications 104 or removing the tag assigned to the communication.

The illustration of communications environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, communications manager 114 in computer system 116 is shown as a separate component from communications system 102. In other illustrative examples, communications manager 114 may be part of communications system 102. As another example, monitoring tool 200 may send information 300 to analyzer 202 when communications 104 occur. As still another example, controller 204 may update at least one of use 400, score 404, or potential changes 134 in graphical user interface 120 as communications 104 occur.

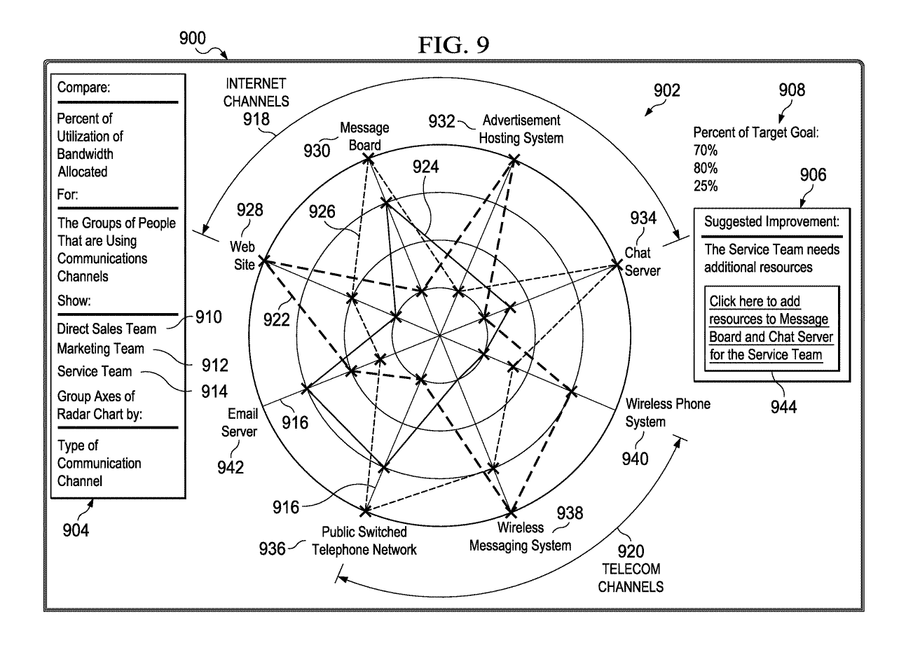

FIGS. 9-13 are illustrative examples of a graphical user interface used to manage communications for groups of people. With reference first to FIG. 9, an illustration of a radar chart in a graphical user interface for managing communications is depicted in accordance with an illustrative embodiment. As depicted, graphical user interface 900 is an example of one implementation for graphical user interface 120 shown in block form in FIG. 1.

In this illustrative example, graphical user interface 900 includes a number of different graphical elements. As depicted, graphical user interface 900 includes radar chart 902, control 904, change control 906, and scores 908. Radar chart 902 is an example of radar chart 128 shown in block form in FIG. 1. Control 904 is an example of control 700 shown in block form in FIG. 7. Control 904 and change control 906 are graphical controls. Scores 908 are examples of score 404 shown in block form in FIG. 4.

As depicted, teams of people 106 are selected in control 904 for comparison on radar chart 902. In this illustrative example, teams of people 106 selected in control 904 are depicted. Teams of people 106 selected in control 904 include direct sales team 910, marketing team 912, and service team 914, in this illustrative example.

Radar chart 902 includes axes 916 for communications channels 110. Axes 916 are an example of axes 130 shown in block form in FIG. 1 and FIG. 7. As depicted, axes 916 are arranged on radar chart 902 based on types of communications channels 110. In this illustrative example, the types of communications channels 110 include internet channels 918 and telecom channels 920.

In this illustration, use 922 of communications channels 110 on axes 916 is for marketing team 912. Use 924 of communications channels 110 on axes 916 is for service team 914. Use 926 of communications channels 110 on axes 916 is for direct sales team 910. Use 922, use 924, and use 926 are examples of use 400 shown in block form in FIG. 4 and FIG. 7. As depicted, these uses are for a percent of utilization of resources 140 allocated to communications channels 110 for teams of people 106.

In this illustrative example, communications channels 110 in internet channels 918 include web site 928, message board 930, advertisement hosting system 932, and chat server 934. Communications channels 110 in telecom channels 920 include public switched telephone network 936, wireless messaging service 938, and wireless phone system 940. Communications channels 110 also include email server 942.

As depicted, change control 906 depicts a suggestion of changes based on potential changes 134. In this illustrative example, the suggestion of changes depicts that service team 914 needs additional resources from resources 140. Change control 906 includes button 944 for generating request to implement potential changes 708. In this illustrative example, potential changes 134 depicted in change control 906 are to add resources from resources 140 to message board 930 and chat server 934 for service team 914.

Thus, graphical user interface 900 may be used to compare uses of communications channels 110 by teams of people 106. Additionally, graphical user interface 900 may be used to manage allocations of resources 140 for communications channels 110 to teams of people 160.

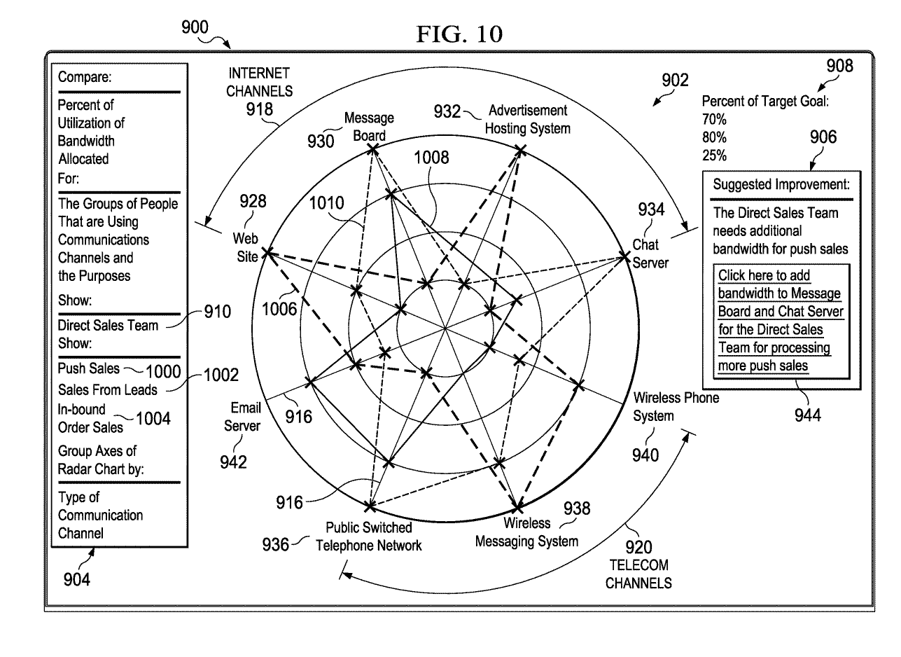

With reference to FIG. 10, an illustration of a radar chart in a graphical user interface for managing communications in a graphical user interface is depicted in accordance with an illustrative embodiment. In this illustration, graphical user interface 900 shows a percent of utilization of bandwidth allocated to communications channels 110 for direct sales team 910 instead of a percent of utilization of resources 140 allocated to communications channels 110 for teams of people 106 shown in FIG. 9. In this illustrative example, the percent of utilization of bandwidth allocated to communications channels 110 for direct sales team 910 is compared for types of communications 104.

As depicted, types of communications 104 are selected in control 904 for comparison on radar chart 902. In this illustrative example, types of communications 104 selected in control 904 are depicted. Types of communications 104 in control 904 include push sales 1000, sales from leads 1002, and in-bound order sales 1004, in this illustrative example.

In this illustration, use 1006 of communications channels 110 is for in-bound order sales 1004 for direct sales team 910. Use 1008 of communications channels 110 is for sales from leads 1002 for direct sales team 910. Use 1010 of communications channels 110 is for push sales 1000 for direct sales team 910. Use 1006, use 1008, and use 1010 are examples of use 400 shown in block form in FIG. 4 and FIG. 7. As depicted, these uses are for the percent of utilization of bandwidth allocated to communications channels 110 for direct sales team 910.

In this illustration, change control 906 depicts that direct sales team 910 needs additional bandwidth for push sales 1000. In this illustrative example, potential changes 134 depicted in change control 906 are to add bandwidth to message board 930, chat server 934, and public switched telephone network 936 for service team 914.

Thus, graphical user interface 900 may be used to compare uses of bandwidth for communications channels 110 by teams of people 106. Additionally, graphical user interface 900 may be used to manage allocations of bandwidth for communications channels 110 to teams of people 160.

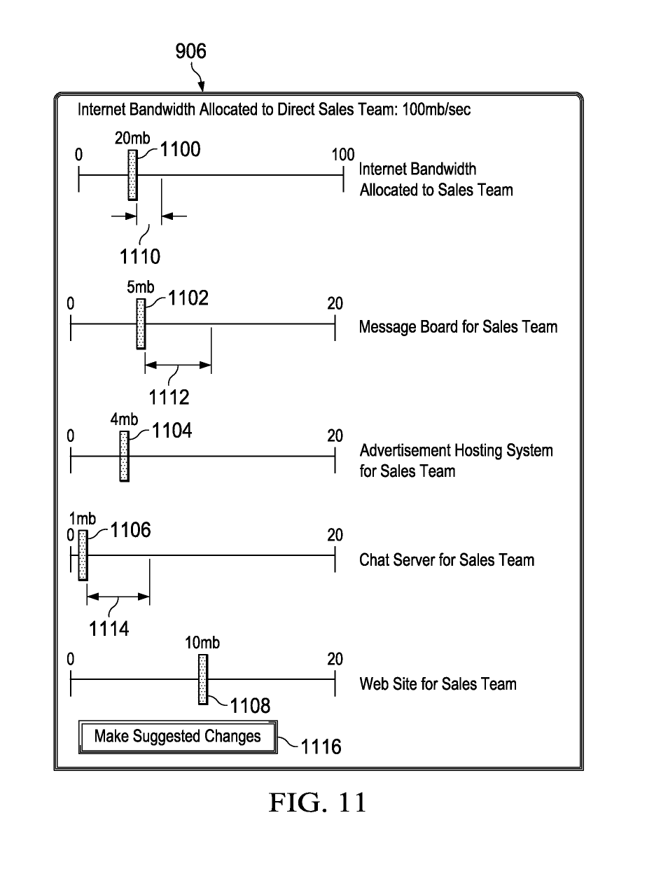

With reference next to FIG. 11, an illustration of a control in a graphical user interface for managing communications in a graphical user interface is depicted in accordance with an illustrative embodiment. In this illustrative example, change control 906 includes a number of sliders for changing the bandwidth allocated to communications channels 110 in internet channels 918 for direct sales team 910. In this illustration, button 944 has been selected in FIG. 10.

As depicted, change control 906 includes slider 1100 for bandwidth allocated to internet channels 918 for direct sales team 910. Slider 1102 is for bandwidth allocated to message board 930 for direct sales team 910. Slider 1104 is for bandwidth allocated to advertisement hosting system 932 for direct sales team 910. Slider 1106 is for bandwidth allocated to chat server 934 for direct sales team 910. Slider 1108 is for bandwidth allocated to web site 928 for direct sales team 910.

In this illustration, change control 906 depicts an amount of bandwidth currently allocated to direct sales team 910. Change control 906 depicts an amount of additional bandwidth needed for direct sales team 910. The amount of additional bandwidth needed for direct sales team 910 is indicted by arrow 1110.

Change control 906 depicts an amount of additional bandwidth needed for message board 930 for direct sales team 910. The amount of additional bandwidth needed for message board 930 for direct sales team 910 is indicted by arrow 1112. Change control 906 also depicts an amount of additional bandwidth needed for chat server 934 for direct sales team 910. The amount of additional bandwidth needed for chat server 934 for direct sales team 910 is indicted by arrow 1114.

These sliders can be moved along the arrows to the suggested changes or to any other suitable position to change the amount of bandwidth allocated. As depicted, change control 906 includes button 1116. Selecting button 1116 causes the sliders to move to the locations suggested by the arrows.

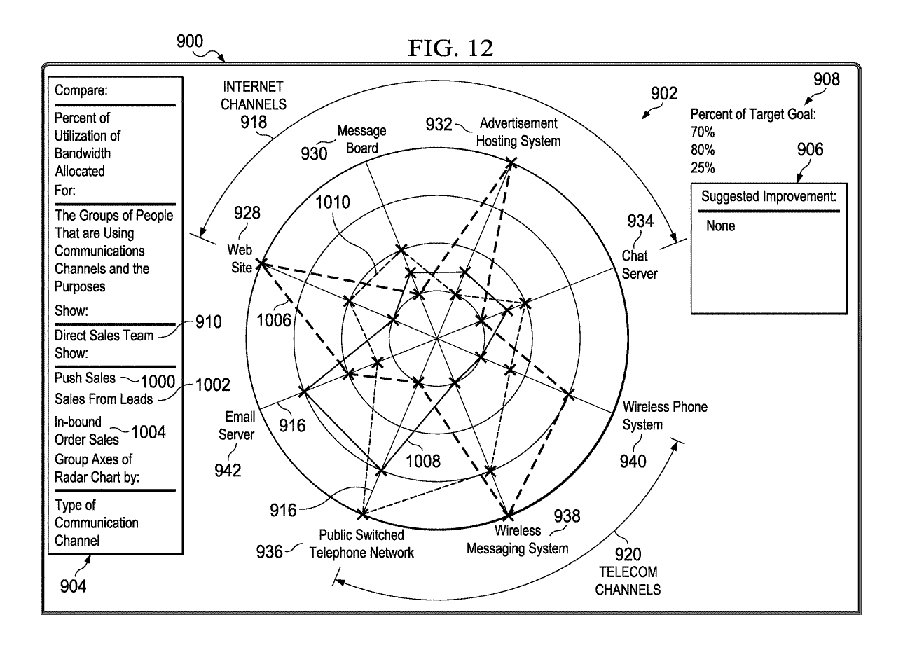

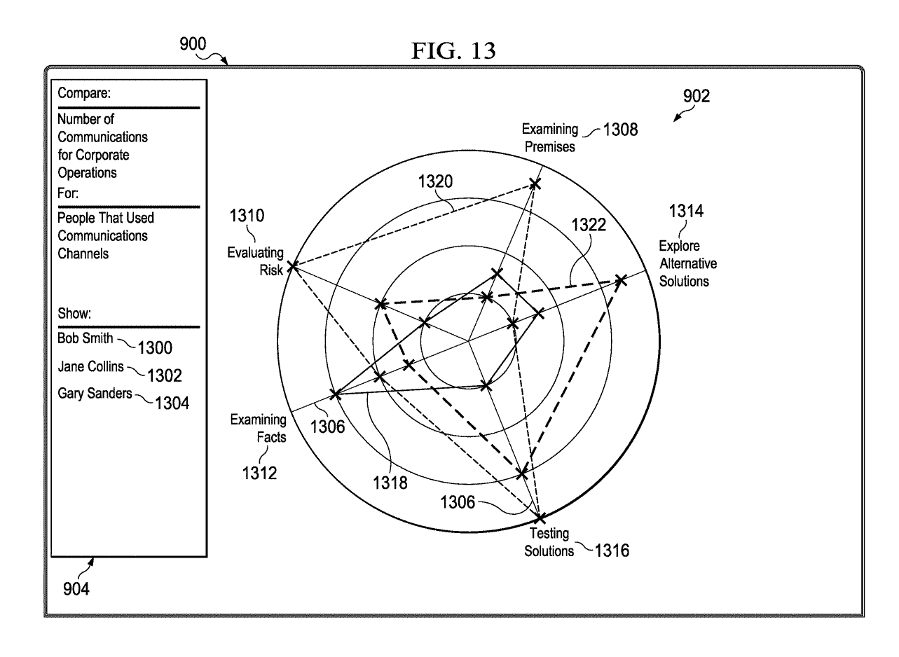

With reference now to FIG. 12, an illustration of a radar chart in a graphical user interface for managing communications in a graphical user interface is depicted in accordance with an illustrative embodiment. In this illustrative example, button 944 has been selected in FIG. 10.

As depicted, the percent utilization for use of message board 930 and chat server 934 is now depicted as lower for message board 930 and chat server 934. Thus indicating additional bandwidth is now available for direct sales team 910 to achieve a higher score in scores 908 for push sales 1000.

With reference now to FIG. 13, an illustration of a radar chart in a graphical user interface for managing communications in a graphical user interface is depicted in accordance with an illustrative embodiment. In this illustration, graphical user interface 900 shows a number of communications 104 for sub-objectives of corporate operations 508 for a group of people 106 instead of a percent of utilization of resources 140 allocated to communications channels 110 for teams of people 106 shown in FIG. 9. In this illustrative example, the number of communications 104 for sub-objectives of corporate operations 508 is compared for the group of people 106.

As depicted, the group of people 106 is selected in control 904 for comparison on radar chart 902. In this illustrative example, the group of people 106 selected in control 904 is depicted. The group of people 106 includes person 1300, person 1302, and person 1304.

In this illustrative example, radar chart 902 includes axes 1306 for the sub-objectives of corporate operations 508. Axes 1306 are an example of axes 130 shown in block form in FIG. 1. In this illustrative example, the types of corporate operations 508 include examining premises 1308, evaluating risk 1310, examining facts 1312, exploring alternative solutions 1314, and testing solutions 1316.

In this illustration, use 1318 of communications channels 110 for the types of communications 104 on axes 1306 is for person 1300. Use 1320 of communications channels 110 for the types of communications 104 on axes 1306 is for person 1302. Use 1322 of communications channels 110 for the types of communications 104 on axes 1306 is for person 1304. Use 1318, use 1320, and use 1322 are examples of use 400 shown in block form in FIG. 4.

As depicted, these uses are the number of communications 104 for the sub-objectives of corporate operations 508 for the group of people 106. Thus, graphical user interface 900 may be used to compare the number of communications 104 for sub-objectives of corporate operations 508 made by the group of people 106.

The illustrations of the graphical user interfaces in FIGS. 9-13 are only presented as examples and are not meant to limit the manner in which graphical user interface 120 shown in block form in FIG. 1 may be implemented. For example, axes 916 in FIG. 9 could be any length. In this example, the length of axes 916 in FIG. 9 may be changed to show increased resources 140.

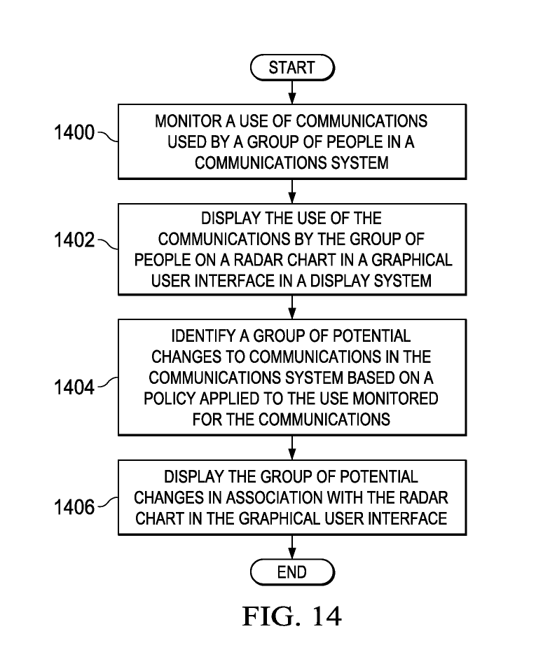

Turning next to FIG. 14, an illustration of a flowchart of a process for managing communications is depicted in accordance with an illustrative embodiment. The process illustrated in FIG. 14 may be implemented within communications environment 100. In particular, the different steps illustrated may be implemented within communications manager 114 in computer system 116 in FIG. 1.

The process begins by monitoring a use of communications used by a group of people in a communications system (step 1400). The process displays the use of the communications by the group of people on a radar chart in a graphical user interface in a display system (step 1402). The radar chart has axes extending from a common origin in which the axes correspond to the use of the communications. In other words, each axis represents a use of the communications, such as communications channel or an objective related to the communications. In one illustrative example, the axis may represent a communications channel that is used to make the communications. In another illustrative example, the axis may represent an objective that communications is related to as made by the group of people.

The process identifies a group of potential changes to communications in the communications system based on a policy applied to the use monitored for in the communications (step 1404). The process displays the group of potential changes in association with the radar chart in the graphical user interface (step 1406) with the process terminating thereafter. The process in FIG. 14 enables a more efficient use of the communications system.

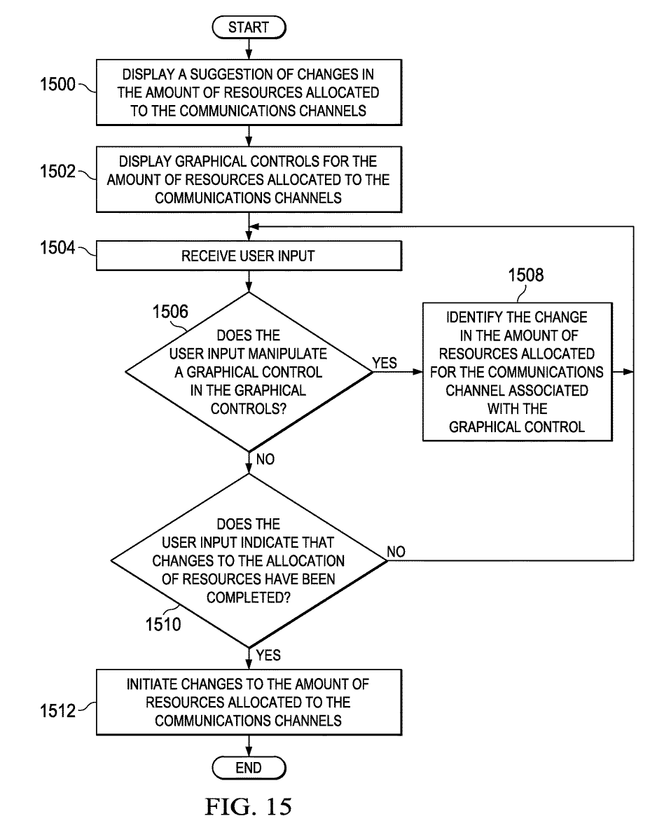

With reference now to FIG. 15, an illustration of a flowchart of a process of steps that may be performed to change an allocation of resources for communications channels based on a visualization of the use of communications channels by a group of people in a radar chart is depicted in accordance with an illustrative embodiment. The process illustrated in FIG. 15 may be implemented in communications manager 114. In this illustrative example, the use of the communications channels is the amount of resources 140 used by communications channels 110.

The process begins by displaying a suggestion of changes in the amount of resources allocated to the communications channels (step 1500). This display may take different forms. For example, the display may be in the form of text, graphics, or other suitable types of visualizations for the operator. The display is made in association with the radar chart so that the operator may view these suggestions of changes along with current uses of the communications channels as displayed on the radar chart. In some cases, the suggestion may be a change to the radar chart itself to indicate the suggestion of changes in resources.

The process displays graphical controls for the amount of resources allocated to the communications channels (step 1502). The process receives user input (step 1504). A determination is made as to whether the user input manipulates a graphical control in the graphical controls (step 1506). If the user input manipulates a graphical control, then the change in the amount of resources allocated for the communications channel associated with the graphical control is identified (step 1508) with the process returning to step 1504.

With reference again the step 1506, if the user input does not manipulate a graphical control, a determination is made as to whether the user input indicates that changes to the allocation of resources have been completed (step 1510). If the user input indicates that changes to the allocation of resources allocated to the indications channels have been completed, the process initiates changes to the amount of resources allocated to the communications channels (step 1512) with the process terminating thereafter. Otherwise, the process returns to step 1504.

In step 1512, the initiation of the change in the amount of resources allocated may take various forms. For example, actual changes to a communications channel may be made. For example, additional servers may be assigned to a communications channel. In another illustrative example, a work order may be generated and sent to change the allocation of resources.

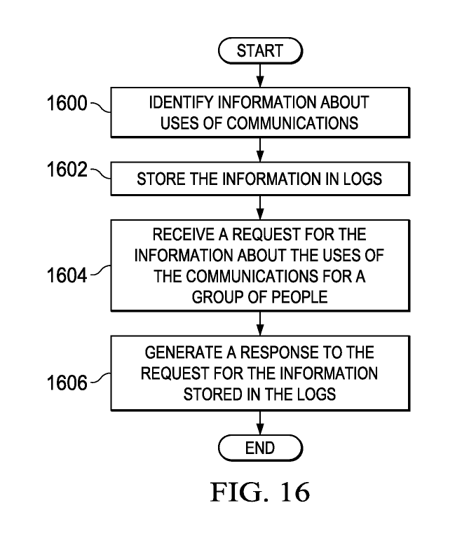

With reference next to FIG. 16, an illustration of a flowchart of a process for monitoring a use of communications channels is depicted in accordance with an illustrative embodiment. The process in this illustration is one example of an implementation for step 1400 in FIG. 14. The process illustrated in FIG. 16 may be implemented in communications environment 100 in FIG. 1. For example, the process may be implemented as steps performed by monitoring tool 200 in FIG. 2 and FIG. 3.

The process begins by identifying information about uses of communications (step 1600). Step 1600 may identify uses in various forms. For example, the use identified in this flowchart may be a use selected from at least one of communications channels and objectives. The information identified in step 1600 is selected from at least one of counts of how many times people used the communications channels for communications, amounts of bandwidth used for the communications, amounts of resources used for the communications, purposes of the communications, people that initiated the communications, people assigned to the communications, people that read the communications, people that responded to the communications, the content in the communications, or some other suitable type of information about the use of the communications channels.

The process stores the information in logs (step 1602). The process receives a request for the information about the uses of the communications for a group of people (step 1604). The process generates a response to the request for the information stored in the logs (step 1606) with the process terminating thereafter.

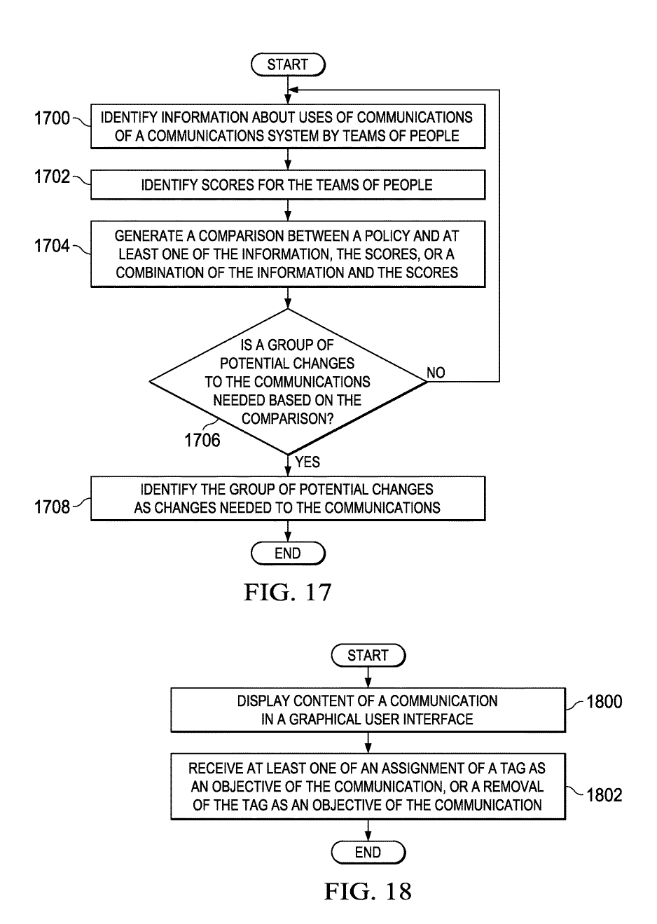

Turning to FIG. 17, an illustration of a flowchart of a process for identifying potential changes to communications is depicted in accordance with an illustrative embodiment. The process in this illustration is one example of an implementation for step 1404 in FIG. 14. The process illustrated in FIG. 17 may be implemented in communications environment 100 in FIG. 1. For example, the process may be implemented as steps performed by analyzer 202 in FIG. 2 and FIG. 4.

The process begins by identifying information about uses of communications of a communications system by teams of people (step 1700). The uses in step 1700 may be selected from at least one of the use of communications channels or the use of communications that are related to objectives.

The team of people in the teams of people in step 1700 is the group of people in step 1404 in FIG. 14. For example, the information in step 1700 may be identified from the information stored in logs in step 1602 in FIG. 16.

The process identifies scores for the teams of people (step 1702). The scores in step 1702 are for at least one of profit, customer satisfaction, productivity, or some other suitable types of scores. The scores of the teams of people are increased through the communications which took place over the communications channels. For example, when a sales team uses a communications channel to make sales calls with customers, the sales calls are communications that increase profit.

The process generates a comparison between a policy and at least one of the information, the scores, or a combination of the information and the scores (step 1704). The policy in step 1704 includes a group of rules selected from at least one of a rule for increasing a goal of communications, a rule for increasing contributions by the group of people using the communications system, a rule for reducing the cost of the communications system, or some other suitable types of rules.

The process determines whether a group of potential changes are needed to the communications based on the comparison (step 1706). The group of potential changes in step 1706 are selected from at least one of a change in resources allocated in the communications system, a change in how people make communications, a priority of use for the types of communications, a priority of use for communications channels, an addition of a new communications channel, a removal of a current communications channel, or other suitable types of potential changes.

For example, when a percent of utilization of a communications channel for the sales team does not meet a rule in the policy, the potential change identified by the process may include a potential change in resources allocated to the communications channel in the communications system for the sales team. As another example, the potential change in resources allocated to the to the communications channel in the communications system for the sales team may be in response to both the percent of utilization of a communications channel for the sales team not meeting the rule in the policy and a profit of the sales team not meeting another rule in the policy. In other words, the increase in resources for use by the sales team may be to increase the profit for the sales team through the use of the resources.

As depicted, if the group potential changes are needed, the process identifies the group of potential changes as changes needed to the communications (step 1708) with the process terminating thereafter. Otherwise, the process returns to step 1700.

Turning next to FIG. 15, an illustration of a flowchart of a process for tagging communications is depicted in accordance with an illustrative embodiment. The process illustrated in FIG. 18 may be implemented in communications environment 100 in FIG. 1. For example, the process may be implemented as steps performed by tagging system 206 in FIG. 2 and FIG. 8.

The process begins by displaying content of a communication in a graphical user interface (step 1800). The communication is an example of a communication in communications 104. For example, when the communication is an email, the content is selected from at least one of the title of the email or the body of the email.

The process receives at least one of an assignment of a tag as an objective of the communication, or a removal of the tag as an objective of the communication (step 1802) with the process terminating thereafter. For example, the assignment of the tag as the objective of the communication may be based on text entered by operator 122 in assigning a tag that specifies the objective. The objective is an example of objectives 150 in FIG. 5.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, the process in FIG. 17 may perform steps 1700 and 1702 substantially concurrently with step 1704. In this example, the comparison made in step 1704 may be made as the information is identified in step 1700 and the scores are identified in step 1702.

As another example, with reference again to step 1404 in FIG. 14, if a group of potential changes is not needed the process in FIG. 14 may include an additional step for displaying that a group of potential changes is not needed in association with the radar chart in the graphical user interface.

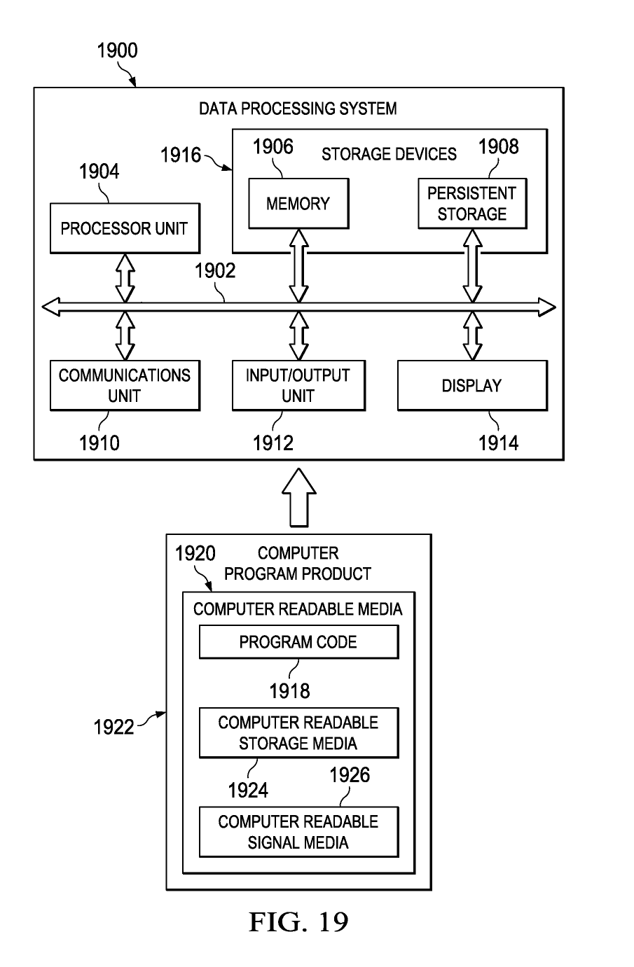

Turning now to FIG. 19, an illustration of a block diagram of a data processing system is depicted in accordance with an illustrative embodiment. Data processing system 1900 may be used to implement one or more data processing systems in communications devices 112, communications channels 110, and computer system 116. In this illustrative example, data processing system 1900 includes communications framework 1902, which provides communications between processor unit 1904, memory 1906, persistent storage 1908, communications unit 1910, input/output (I/O) unit 1912, and display 1914. In this example, communications framework 1902 may take the form of a bus system.

Processor unit 1904 serves to execute instructions for software that may be loaded into memory 1906. Processor unit 1904 may be a number of processors, a multi-processor core, or some other type of processor, depending on the particular implementation.

Memory 1906 and persistent storage 1908 are examples of storage devices 1916. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1916 may also be referred to as computer readable storage devices in these illustrative examples. Memory 1906, in these examples, may be, for example, a random access memory or any other suitable volatile or non-volatile storage device. Persistent storage 1908 may take various forms, depending on the particular implementation.

For example, persistent storage 1908 may contain one or more components or devices. For example, persistent storage 1908 may be a hard drive, a flash memory, a rewritable optical disk, a rewritable magnetic tape, or some combination of the above. The media used by persistent storage 1908 also may be removable. For example, a removable hard drive may be used for persistent storage 1908.

Communications unit 1910, in these illustrative examples, provides for communications with other data processing systems or devices. In these illustrative examples, communications unit 1910 is a network interface card.

Input/output unit 1912 allows for input and output of data with other devices that may be connected to data processing system 1900. For example, input/output unit 1912 may provide a connection for user input through at least of a keyboard, a mouse, or some other suitable input device. Further, input/output unit 1912 may send output to a printer. Display 1914 provides a mechanism to display information to a user.

Instructions for at least one of the operating system, applications, or programs may be located in storage devices 1916, which are in communication with processor unit 1904 through communications framework 1902. The processes of the different embodiments may be performed by processor unit 1904 using computer-implemented instructions, which may be located in a memory, such as memory 1906.

These instructions are referred to as program code, computer usable program code, or computer readable program code that may be read and executed by a processor in processor unit 1904. The program code in the different embodiments may be embodied on different physical or computer readable storage media, such as memory 1906 or persistent storage 1908.

Program code 1918 is located in a functional form on computer readable media 1920 that is selectively removable and may be loaded onto or transferred to data processing system 1900 for execution by processor unit 1904. Program code 1918 and computer readable media 1920 form computer program product 1922 in these illustrative examples. In one example, computer readable media 1920 may be computer readable storage media 1924 or computer readable signal media 1926. In these illustrative examples, computer readable storage media 1924 is a physical or tangible storage device used to store program code 1918 rather than a medium that propagates or transmits program code 1918.

Alternatively, program code 1918 may be transferred to data processing system 1900 using computer readable signal media 1926. Computer readable signal media 1926 may be, for example, a propagated data signal containing program code 1918. For example, computer readable signal media 1926 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1900 are not meant to provide architectural limitations to the manner in which different embodiments may be implemented. The different illustrative embodiments may be implemented in a data processing system including components in addition to or in place of those illustrated for data processing system 1900. Other components shown in FIG. 19 can be varied from the illustrative examples shown. The different embodiments may be implemented using any hardware device or system capable of running program code 1918.

Thus, the illustrative embodiments provide a method and apparatus for managing the communications system. One or more technical solutions are present that overcome a technical problem with managing resources for communications channels in a communications system. A communications manager, such as communications manager 114 in FIG. 1, displays the use of communications in a radar chart to provide a visualization of information that may be used by an operator or other people to manage a communications system.

Further, the communications manager also identifies and displays a group of potential changes as to how communications are made. For example, the group of potential changes may include changing allocations of resources to communications channels. These potential changes are displayed in the graphical user interface in association with the display of a radar chart. The operator also may interact with the communications manager through graphical user interface to implement one or more of the potential changes. In this manner, the technical effect of a more efficient use of a communications system may occur using one or more of the technical solutions as described herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for managing communications comprising:
monitoring, by a computer system, a use of communications by a group of people in a communications system;
displaying, by the computer system, the use of the communications by the group of people on a radar chart in a graphical user interface in a display system, wherein the radar chart has axes extending from a common origin in which the axes correspond to the use of the communications;
identifying, by the computer system, a group of potential changes to the communications in the communications system based on a policy applied to the use monitored for in the communications; and
displaying, by the computer system, the group of potential changes in association with the radar chart in the graphical user interface, enabling a more efficient use of the communications system.

2. The method of claim 1, wherein the use of communications are selected from at least one of communications channels or objectives.

3. The method of claim 1, wherein identifying the group of potential changes to the communications based on the policy comprises:
identifying, by the computer system, the group of potential changes to the communications based on the policy, wherein the group of potential changes is selected from at least one of a change in resources allocated in the communications system, a change in how people make the communications, a priority of use for types of the communications, a priority of use for communications channels, an addition of a new communications channel, or a removal of a current communications channel.

4. The method of claim 2, wherein the use of the communications channels is selected from at least one of a number of communications, bandwidth used for the communications, how long the communications last, or resources used.

5. The method of claim 1, wherein the policy includes a group of rules selected from at least one of increasing a goal of the communications, increasing contributions by the group of people using the communications system, meeting an objective, or reducing a cost of the communications system.

6. The method of claim 1, wherein the use is an amount of resources used and the group of potential changes is a suggestion of changes in the amount of resources allocated to communications channels and further comprising:
displaying, by the computer system, graphical controls for the amount of resources allocated to the communications channels; and
initiating, by the computer system, changes to the amount of resources allocated to the communications channels based on user input manipulating a graphical control in graphical controls.

7. The method of claim 6, wherein the amount of resources used are used by teams of people in an organization and the amount of resources used include amounts of the resources used by the teams.

8. The method of claim 7, wherein the policy comprises a rule to increase a goal of the communications and further comprising:
displaying, by the computer system, scores for the teams of people for at least one of profit, customer satisfaction, meeting an objective, or productivity.

9. The method of claim 1, wherein the use of the communications are the communications that meet objectives, and wherein monitoring, by the computer system, the use of the communications by the group of people in the communications system comprises:
monitoring, by the computer system, the communications made by the group of people in the communications system that are related to a group of objectives.

10. The method of claim 9, wherein monitoring, by the computer system, the communications made by the group of people in the communications system that are related to the group of objectives further comprises:
identifying, by the computer system, tags assigned to the communications, wherein a tag in the tags for a communication in the communications identifies an objective in the group of objectives for the communication.

11. The method of claim 1, wherein the policy is for increasing a goal of the communications based on an allocation of resources to communications channels.

12. The method of claim 2, wherein the communications channels are selected from at least one of an electronic mail system, an instant messaging message system, a message board, a private message system, a forum, a voice mail system, a public switched telephone network, a voice over internet protocol call system, a video conference system, a social network, or a professional network.

13. The method of claim 2, wherein the objectives are selected from at least one of sales, marketing, product development, research, corporate operations, public relations, or customer satisfaction.

14. A computer system comprising:
a display system; and
a communications manager in communication with the display system, wherein the communications manager monitors a use of communications used by a group of people in a communications system; displays the use of the communications by the group of people on a radar chart in a graphical user interface in a display system, wherein the radar chart has axes extending from a common origin in which the axes correspond to the use of the communications; identifies a group of potential changes to the communications in the communications system based on a policy applied to the use monitored for in the communications; and displays the group of potential changes in association with the radar chart in the graphical user interface, enabling a more efficient use of the communications system.

15. The computer system of claim 14, wherein the use of the communications is selected from at least one of communications channels or objectives.

16. The computer system of claim 14, wherein in identifying the group of potential changes to the communications based on the policy, the communications manager identifies the group of potential changes to the communications based on the policy, wherein the group of potential changes is selected from at least one of a change in resources allocated in the communications system, a change in how people make the communications, a priority of use for types of the communications, a priority of use for communications channels, an addition of a new communications channel, or a removal of a current communications channel.

17. The computer system of claim 14, wherein the use is selected from at least one of a number of communications, bandwidth used for the communications, how long the communications last, or resources used.

18. The computer system of claim 14, wherein the policy includes a group of rules selected from at least one of increasing a goal of the communications, increasing contributions by the group of people using the communications system, meeting an objective, or reducing a cost of the communications system.

19. The computer system of claim 14, wherein the use is an amount of resources used and the group of potential changes is a suggestion of changes in the amount of resources allocated to communications channels, and wherein the communications manager displays graphical controls for the amount of resources allocated to the communications channels and initiates changes to the amount of resources allocated to the communications channels based on user input manipulating a graphical control in the graphical controls.

20. The computer system of claim 19, wherein the amount of resources used are used by teams of people in an organization and the amount of resources used include amounts of the resources used by the teams.

21. The computer system of claim 20, wherein the policy comprises a rule to increase a goal of the communications, and wherein the communications manager displays a score for a team of people in the teams of people for at least one of profit, customer satisfaction, meeting objectives, or productivity.

22. The computer system of claim 14, wherein the use of the communications are the communications that meet objectives, and wherein in monitoring the use of communications by the group of people in the communications system, the communications manager monitors the communications made by the group of people in the communications system that are related to a group of objectives.

23. The computer system of claim 14, wherein the policy is for increasing a goal of the communications based on an allocation of resources to communications channels.

24. The computer system of claim 15, wherein the communications channels are selected from at least one of an electronic mail system, an instant messaging message system, a message board, a private message system, a forum, a voice mail system, a public switched telephone network, a voice over internet protocol call system, a video conference system, a social network, or a professional network.

25. The computer system of claim 15, wherein the objectives are selected from at least one of sales, marketing, product development, research, corporate operations, public relations, or customer satisfaction.

26. A computer program product for managing communications, the computer program product comprising:
a computer readable storage media;
first program code, stored on the computer readable storage media, for monitoring a use of communications used by a group of people in a communications system;
second program code, stored on the computer readable storage media, for displaying the use of the communications by the group of people on a radar chart in a graphical user interface in a display system, wherein the radar chart has axes extending from a common origin in which the axes correspond to the use of the communications;
third program code, stored on the computer readable storage media, for identifying a group of potential changes to the communications in the communications system based on a policy applied to the use monitored for in the communications; and
fourth program code, stored on the computer readable storage media, for displaying the group of potential changes in association with the radar chart in the graphical user interface, enabling a more efficient use of the communications system.

27. The computer program product of claim 26, wherein the use of the communications are selected from at least one of communications channels or objectives.

28. The computer program product of claim 26, wherein the third program code comprises:
program code, stored on the computer readable storage media, for identifying the group of potential changes to the communications based on the policy, wherein the group of potential changes is selected from at least one of a change in resources allocated in the communications system, a change in how people make the communications, a priority of use for types of the communications, a priority of use for communications channels, an addition of a new communications channel, or a removal of a current communications channel.

29. The computer program product of claim 26, wherein the use is selected from at least one of a number of communications, bandwidth used for the communications, how long the communications last, or resources used.

30. The computer program product of claim 26, wherein the policy includes a group of rules selected from at least one of increasing a goal of the communications, increasing contributions by the group of people using the communications system, meeting an objective, or reducing a cost of the communications system.

31. The computer program product of claim 26, wherein the use is an amount of resources used and the group of potential changes is a suggestion of changes in the amount of resources allocated to communications channels and further comprising:
fifth program code, stored on the computer readable storage media, for displaying graphical controls for the amount of resources allocated to the communications channels; and
sixth program code, stored on the computer readable storage media, for initiating changes to the amount of the resources allocated to the communications channels based on user input manipulating a graphical control in graphical controls.

32. The computer program product of claim 31, wherein the amount of resources used are used by teams of people in an organization and the amount of resources used include amounts of the resources used by the teams.

33. The computer program product of claim 32, wherein the policy comprises a rule to increases a goal of the communications and further comprising:
seventh program code, stored on the computer readable storage media, for displaying scores for the teams of people for at least one of profit, customer satisfaction, meeting objectives, or productivity.

34. The computer program product of claim 26, wherein the policy is for increasing a goal of the communications based on an allocation of resources to communications channels.
